(19) United States
(12) Patent Application Publication
(10) Pub. No.: US 2026/0299110 A1
(43) Pub. Date: Oct. 1, 2026

(54) AUTOMATED AERIAL THREAT DETECTION AND DETERRENCE SYSTEM

(71) Applicant: Skyline Guard, Inc., San Jose, CA (US)

(72) Inventor: Mohanad Abou Khair, Dearborn Heights, MI (US)

(21) Appl. No.: 19/578,111

(22) Filed: Mar. 25, 2026

Related U.S. Application Data
(60) Provisional application No. 63/778,790, filed on Mar. 27, 2025.

(51) Int. Cl. G01S 13/58; A01M 29/10; A01M 29/16; G01S 7/41; G06N 3/045

(52) U.S. Cl. CPC G01S 13/58; A01M 29/10; A01M 29/16; G01S 7/411; G06N 3/045

(57) ABSTRACT

A system for automated avian threat detection and deterrence comprises a radar detection system configured to collect real-time spatial and temporal avian data including position, velocity, altitude, and radar cross-section (RCS) data. The system further comprises a central AI processing node comprising a spatiotemporal AI model configured to analyze sequences of the real-time spatial and temporal avian data to generate an initial trajectory prediction for detected avian activity, apply learned corrections to the initial trajectory prediction based on patterns observed in historical radar data and species-specific behavioral models to generate a corrected predicted trajectory, and continuously refine the corrected predicted trajectory as new radar data is received. The system further comprises one or more deterrent devices configured to activate deterrence measures along the corrected predicted trajectory to proactively deter avian threats before entering a protected zone.

### CROSS-REFERENCE TO RELATED APPLICATIONS

This application claims priority to U.S. Provisional Application No. 63/778,790, filed Mar. 27, 2025, the entire contents of which are hereby incorporated by reference herein.

### FIELD OF INVENTION

The present disclosure relates to automated wildlife management and deterrence systems, and more particularly to AI-driven systems that use spatiotemporal radar analysis for avian threat detection, trajectory prediction, and coordinated autonomous deterrent deployment.

### BACKGROUND

Bird strikes and wildlife interference can pose considerable risks to aviation safety and sensitive infrastructure operations. In the aviation context, bird strikes may cause aircraft damage, flight delays, and in some cases, threats to human lives. Traditional methods for wildlife hazard management at airports and other facilities have relied on manual observation, visual detection systems, and localized deterrents. These conventional approaches may lack real-time responsiveness and accuracy, particularly when dealing with dynamic, fast-moving bird flocks that can rapidly change direction and altitude.

Radar systems used in current wildlife management implementations are often passive in nature. Existing object detection algorithms may fail to adequately consider the temporal evolution of radar signals, instead focusing primarily on instantaneous position data. As a result, such systems may lack the capacity to anticipate bird movements based on historical trajectory patterns, which can render them less effective at preemptively mitigating risks associated with rapidly changing flock trajectories. Without predictive capabilities, these systems may merely react to threats after they have already materialized, potentially reducing the time available for effective intervention.

Furthermore, current deterrent systems are often localized and may operate independently of one another. Many existing deterrent installations rely on manual operation and lack coordinated behavior or adaptability to dynamic bird behaviors. This can lead to inefficient or misdirected deterrence efforts, potentially creating gaps in airspace coverage and response delays. When multiple deterrent devices are deployed across a site, the absence of coordination mechanisms may result in redundant activations in some areas while leaving other areas unprotected.

### BRIEF DESCRIPTION OF FIGURES

Non-limiting and non-exhaustive examples are described with reference to the following figures.

FIG. 1 illustrates a system architecture of an automated wildlife threat detection and deterrence system, in accordance with one or more embodiments.

FIG. 2 illustrates a high-level operation of the automated wildlife threat detection and deterrence system, in accordance with one or more embodiments.

FIG. 3 illustrates an operational flow of the automated wildlife threat detection and deterrence system, in accordance with one or more embodiments.

FIG. 4 illustrates a radar data handling and preprocessing operational flow, in accordance with one or more embodiments.

FIG. 5 illustrates an architecture and data flow of a central AI core, in accordance with one or more embodiments.

FIG. 6 illustrates an operational flow of a wildlife deterrence system with dynamic adaptive deterrence, in accordance with one or more embodiments.

FIG. 7 illustrates an architecture and data flow of a single AI-enabled turret, in accordance with one or more embodiments.

FIG. 8 illustrates an operational flow of a turret node entering failover mode upon losing connection to a central AI core, in accordance with one or more embodiments.

FIG. 9 illustrates an example operational flow of a mitigation scenario, in accordance with one or more embodiments.

FIG. 10 illustrates a computer system with which some embodiments are implemented.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In accordance with various embodiments, the present disclosure describes systems and methods for automated wildlife threat detection and deterrence. Such systems may be deployed in environments where avian activity poses potential risks to operations, equipment, or safety. Airports and airfields represent one context in which wildlife management systems may be deployed. In some implementations, the system may be configured to protect a corridor of approximately 3 to 5 miles used for aircraft takeoff and landing, as a considerable proportion of bird strikes, such as approximately 75%, may occur within this corridor during takeoff and landing operations. The technologies described herein may also find application at energy facilities such as wind farms and solar installations, critical infrastructure sites including defense installations and industrial facilities, and agricultural operations where crop protection from avian activity may be desired.

Radar-based detection systems may be employed to monitor airspace for the presence of birds and other wildlife. Such radar systems may be capable of detecting individual birds as well as flocks, and may provide data regarding position, velocity, altitude, heading, and radar cross-section characteristics of detected objects. The continuous collection of radar data over time may enable the tracking of wildlife movements and the analysis of flight patterns within a monitored area.

Artificial intelligence and machine learning techniques may be applied to radar data streams to perform various analytical functions. These functions may include the detection and classification of wildlife based on radar signatures, the prediction of future trajectories based on observed movement patterns, and the assessment of risk levels associated with detected wildlife activity. In some implementations, AI models may be trained on historical radar data to improve their accuracy in detecting, classifying, and predicting wildlife behavior.

In some implementations, AI models may be trained using videos and pictures of different bird species to improve species classification accuracy. The system may connect to external bird identification databases or application programming interfaces (APIs), such as eBird, to identify common species found around specific deployment sites. For example, at airport deployments, the system may query such external databases to obtain information about bird species commonly observed in the vicinity of a particular airport, enabling the system to be prepared for local bird populations before deployment. This location-specific species information may be used to pre-configure species-specific deterrence profiles and to prioritize training data relevant to the expected avian activity at a given site.

Deterrent systems may be deployed to discourage wildlife from entering or remaining in protected areas. Such deterrent systems may include acoustic devices capable of emitting directional sound, as well as visual deterrents such as lights or lasers. In some implementations, multiple deterrent turrets may be distributed across a site to provide coverage of a protected area. The coordination of multiple deterrent devices may enable more effective wildlife management across larger areas and may allow for adaptive responses to dynamic wildlife behavior.

Challenges may arise in the context of predicting bird movements in real-time. Existing detection systems may analyze instantaneous position data but may not adequately consider the temporal evolution of radar signals over time. As a result, such systems may be reactive rather than proactive, responding to threats after they have materialized rather than anticipating and preventing them in advance. The ability to predict where birds will be in the future, rather than simply where they are at a given moment, may be beneficial for effective wildlife management in time-sensitive environments such as airport operations.

Difficulties may also be encountered in coordinating multiple deterrent devices deployed across a site. When individual turrets or other deterrent units operate independently of one another, coverage gaps may emerge, redundant activations may occur, or deterrence efforts may be misdirected. The absence of coordination mechanisms among distributed deterrent devices may reduce the overall effectiveness of a wildlife management system, particularly when addressing dynamic threats such as fast-moving flocks that traverse multiple coverage zones.

Additional challenges may relate to adapting deterrence strategies to different species and behaviors. Different bird species may respond differently to various types of deterrent stimuli, and the parameters that prove effective for one species may be less effective for another. Furthermore, birds may habituate to repetitive stimuli over time, potentially reducing the long-term effectiveness of deterrence efforts that do not vary their approach. A wildlife management system that does not account for species-specific responses and habituation effects may experience diminished effectiveness over time.

System resilience may also present challenges in distributed wildlife management deployments. Communication failures between a central processing system and distributed deterrent devices may compromise deterrence effectiveness if individual devices are unable to operate autonomously during periods of disconnection. The ability to maintain effective wildlife management operations despite intermittent communication failures may be beneficial for ensuring continuous protection of critical areas.

In accordance with various embodiments, the present disclosure provides an automated wildlife threat detection and deterrence system that addresses the challenges described above. The system leverages AI models, such as spatiotemporal AI models, applied to radar data to detect, classify, and mitigate avian threats, as well as to predict future trajectories of those threats. In some implementations, the system uses transformer-based neural networks trained on radar data sequences to perform autonomous detection, classification, and prediction. By integrating predictive AI models with distributed autonomous deterrent turrets, the system may enable anticipatory activation of non-harmful and/or non-lethal deterrent measures, with timing, intensity, and direction optimized to prevent birds from entering hazardous zones before an imminent threat materializes.

A first aspect of the disclosed system relates to spatiotemporal bird trajectory prediction. In some implementations, the system may predict where birds will be in the future, such as 30, 60, or even 120 seconds ahead, based on factors including species characteristics, estimated weight, environmental conditions, and historical movement patterns. The AI analyzes radar signatures and generates initial trajectory predictions, then continuously corrects and refines those predictions as new radar data arrives. This predictive capability enables proactive deterrence, allowing the system to initiate deterrent actions before threats fully materialize rather than merely reacting to threats after they have already entered protected airspace.

A second aspect of the disclosed system relates to distributed turret orchestration and coordination. In some implementations, the system coordinates multiple deterrent turrets to operate as a unified system rather than as independent units. The turrets communicate and coordinate with each other to enable seamless handover of deterrence responsibility as birds move across coverage areas. A distributed protocol may be employed to negotiate roles among turrets, such as lead, support, and observer roles, based on factors including proximity to the predicted trajectory, angular position relative to the threat, and current system load. This coordination prevents coverage gaps and redundant activations, and enables the system to guide birds in a desired direction away from protected zones through coordinated multi-turret deterrence actions.

A third aspect of the disclosed system relates to species-specific adaptive deterrence. In some implementations, the system employs species-specific deterrence strategies that account for the different behaviors and sensitivities of various bird species. The AI may select combinations of frequencies, intensity levels, and targeting angles based on species identification derived from radar signatures. The system may learn which deterrence parameters prove effective for particular species and store these as species-specific deterrence profiles. When a similar bird or flock is encountered in the future, the system may immediately apply the previously learned effective parameters without repeating the learning process, thereby improving response time and deterrence effectiveness over successive encounters.

In some implementations, the system monitors bird responses to deterrence actions in real-time using ongoing radar data. This feedback may be used to refine both immediate responses, such as adjusting deterrence parameters during an active deterrence event, and long-term model accuracy through retraining of AI models based on deterrence outcomes. The continuous learning loop may enable the system to improve its effectiveness over time as it accumulates data regarding which deterrence strategies prove effective for various species, flock sizes, and environmental conditions.

The disclosed system may provide various technical advantages over conventional wildlife management approaches. These advantages may include proactive rather than reactive deterrence through trajectory prediction, optimized coverage and reduced redundancy through coordinated multi-turret operation, reduced habituation through adaptive and varied deterrence strategies, enhanced system resilience through failover capabilities that enable autonomous turret operation during communication disruptions, continuous learning and improvement through feedback-driven model refinement, and scalability across different deployment environments ranging from airports to energy facilities to agricultural operations.

The system of the present disclosure may be designed to employ non-harmful and/or non-lethal deterrence methods and may adhere to applicable safety and regulatory guidelines, such as those established by the FAA and USDA for wildlife hazard management. In some implementations, acoustic deterrent devices may reach intensity levels up to 120 dB, which is comparable to the sound level of a jet engine. Given the potential intensity of such deterrents, safety measures may be employed to ensure appropriate use. In some implementations, turrets may include mechanical locking mechanisms that can restrict the turret's range of motion to prevent the turret from pointing at unintended targets or restricted areas. In some implementations, species-specific intensity and frequency limits may be employed to avoid harm to both birds and humans. Safety compliance checks may be performed before and during deterrence activation to ensure that deterrence parameters remain within acceptable thresholds. Logging and auditing capabilities may be provided to support regulatory compliance and accountability.

The following sections describe the system architecture and operation in greater detail with reference to the figures. The description covers the system components, data processing pipeline, AI core architecture, turret coordination mechanisms, adaptive deterrence strategies, and failover operation modes.

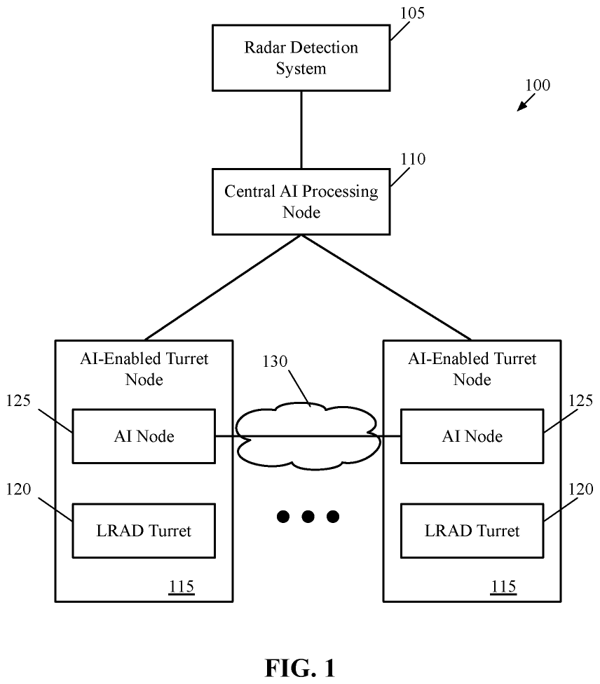

FIG. 1 illustrates a system architecture of an automated wildlife threat detection and deterrence system 100, in accordance with one or more embodiments. The system 100 may be deployed at an airport or airfield to prevent bird strikes and airspace incursions. In addition, the system 100 may be deployed at energy sites such as wind farms, solar fields, or oil and gas platforms, at critical infrastructure sites such as defense installations or other sensitive facilities, or at agricultural fields to protect crops from avian activity.

As shown in FIG. 1, the system 100 includes a radar detection system 105, which represents one or more central or distributed radar systems providing real-time spatial and temporal bird data. In some implementations, the radar detection system 105 is an avian radar system capable of detecting individual birds and flocks and transmitting positional, speed, altitude, direction, and radar cross-section (RCS) data over time. The radar detection system 105 may be capable of continuous monitoring of a deployment area for around-the-clock visibility into airspace risks.

The radar detection system 105 provides information to a central AI processing node 110, which may receive a continuous data feed from the radar. In some implementations, the central AI processing node 110 is a dedicated computing device, such as a high-performance AI unit, that executes an AI threat assessment engine and a dynamic deterrent controller. The AI threat assessment engine may be an AI model, such as a transformer-based spatiotemporal AI model, that detects, classifies, and predicts threats. The central AI processing node 110 may perform radar data analysis, global coordination within the system 100, predictive trajectory modeling, and behavior modeling. In some implementations, the central AI processing node 110 executes on specialized AI computing hardware that combines a CPU with a GPU and LPDDR memory.

The central AI processing node 110 coordinates the operation of a plurality of AI-enabled turret nodes 115, which may communicate via a secured high-speed communication system such as a gigabit Ethernet switch. Each of the turret nodes 115 may be a robotic sound deterrent turret 120, such as a long-range acoustic device (LRAD) turret, with an embedded edge AI module 125 that performs local decision-making, trajectory analysis, and coordination. The turret nodes 115 may be deployed strategically around the deployment area for full coverage. Each turret node 115 may include a command interface for receiving deterrent commands from the central AI processing node 110, which may be an encrypted link in some implementations. The edge AI module 125 can activate the local sound turret 120 and handle local adjustments. In some implementations, the edge AI module 125 may be implemented using embedded AI computing hardware such as an NVIDIA Jetson platform (e.g., Jetson Nano), which provides local GPU-accelerated processing capabilities for real-time decision-making, frequency selection, and trajectory tracking at each turret node. The sound turrets 120 may be directional sound deterrents with adjustable direction, frequency, and power, and receive activation signals based on AI decisions from the edge AI modules 125. In some implementations, the deterrent turrets include other deterrent types, such as lights or lasers. The turret nodes 115 may also include local feedback sensors, such as a local radar, to monitor environmental and target response data.

The turret nodes 115 are connected by an inter-turret communication network 130, in accordance with one or more embodiments. This network 130 may be a high-speed Ethernet or messaging protocol communication mesh, such as one using MQTT or ZeroMQ protocols, that enables real-time data exchange and predictive coordination between the turrets 115. The turrets 115 may share their position, activation status, and threat updates via this network. The turrets 115 can execute coordinated responses with deterrence from multiple different turrets, thereby minimizing gaps and redundancy. In some implementations, the system architecture also includes a command and control interface for human monitoring and intervention. The various components of the system 100 are connected by a high-speed communication system that transmits radar data and AI-derived commands in real-time between these components.

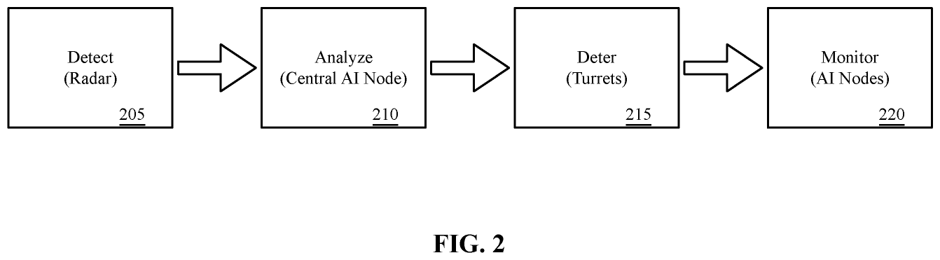

FIG. 2 illustrates a high-level operation of the automated wildlife threat detection and deterrence system, in accordance with one or more embodiments. As shown, the system (e.g., the system 100) performs four main operations that may form a continuous cycle: detecting threats (e.g., birds or flocks), analyzing these threats (to determine future trajectories and classify risks), deterring the threats (e.g., using sound), and monitoring the threats to ensure that they are deterred. These operations may be performed continuously and iteratively, enabling the system to adapt to dynamic wildlife behavior in real-time.

Detection operations 205 may be performed by the radar detection system, which may include one or more radar units deployed across the monitored area. In some implementations, the radar detection system continuously monitors the deployment area for avian activity, detecting individual birds as well as flocks. The detection operations may include the collection of spatial and temporal data such as position, velocity, altitude, heading, and radar cross-section (RCS) characteristics of detected objects. The AI module may assist with initial detection by filtering out other (e.g., non-avian) objects based on radar signature analysis and movement patterns.

Analysis operations 210 are performed primarily at the central AI processing node. In some implementations, the analysis operations include trajectory prediction using spatiotemporal AI models that analyze sequences of radar data to forecast future bird positions. Risk assessment may be performed based on predicted flight paths, proximity to hazardous zones such as runways, species identification, flock size, speed, and altitude. The analysis operations may also include threat classification, such as assigning low, medium, or high risk levels to detected wildlife. Based on the threat characteristics, the central AI processing node may select an appropriate deterrence strategy, including the type of deterrent to deploy and the parameters for that deterrent.

Deterrence operations 215 are performed by the turrets based on the analysis from the central AI processing node. In some implementations, the deterrence operations include selection of the deterrent type (e.g., sound, lights, lasers), configuration of deterrent parameters (e.g., direction, frequency, intensity, duration), and coordinated activation across multiple turrets when appropriate. The turrets may target predicted future positions of the birds rather than their current positions, enabling proactive deterrence that intercepts wildlife before they enter protected zones.

Monitoring operations 220 are performed by the central AI node as well as, in some cases, the distributed AI nodes at the turrets. The monitoring operations may include real-time tracking of bird responses to deterrence actions using ongoing radar data. This feedback loop enables the system to assess deterrence effectiveness and dynamically adjust deterrence parameters if initial efforts are unsuccessful. For example, if birds do not change course in response to initial deterrence, the system may increase intensity, shift targeting direction, or activate additional turrets. The monitoring operations may also include logging of deterrence outcomes for model training and regulatory compliance purposes. Together, these four operations form a continuous cycle that enables adaptive and effective wildlife management.

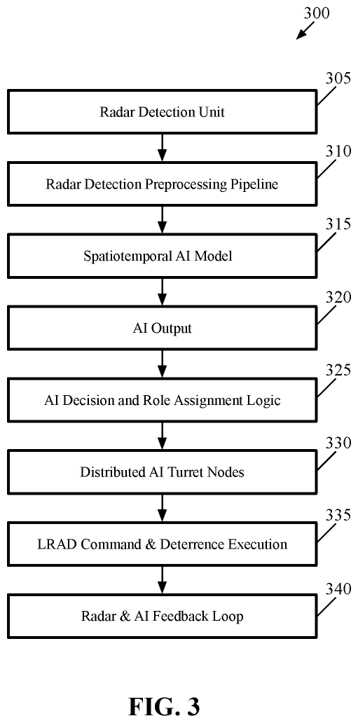

FIG. 3 illustrates an operational flow 300 of the automated wildlife threat detection and deterrence system (e.g., the system 100), in accordance with one or more embodiments. Various components of this overall operation flow will be elaborated upon below.

As shown, a radar detection unit 305 generates bird tracking and motion data. In some implementations, the radar detection unit 305 detects one or more birds and/or flocks and streams raw data to the central AI node. The radar detection unit 305 may capture raw radar reflections from avian radar sensors, extract object positions, velocity, heading, and RCS signature, log timestamped data for temporal analysis, and apply initial calibration to ensure accuracy. The raw radar data may include positional coordinates (x, y, z), RCS values, velocity (speed and direction) vectors, and timestamps. The radar detection unit 305 may be capable of continuous monitoring for around-the-clock visibility into airspace risks. It should be noted that while this application primarily describes radar data, other types of input data (e.g., image and/or video frames) may be used as well in some implementations.

The raw data is run through a radar data preprocessing pipeline 310 that performs noise filtering, signal normalization, and/or feature extraction (to generate position, velocity (speed and direction), and radar cross section (RCS) data). In some implementations, the radar data preprocessing pipeline 310 is designed for cleaning, filtering, and structuring the raw radar data. The preprocessing module may remove environmental interference (e.g., weather, terrain, clutter), isolate moving objects from stationary background noise, and normalize signal intensity across multiple radar scans. Other objects may be filtered out via RCS signature matching, velocity and flight pattern heuristics, and noise reduction algorithms. In some implementations, the radar data preprocessing pipeline 310 removes duplicate or spurious detections. Feature extraction may identify bird-specific RCS signatures, compute object size, altitude, speed, acceleration, and heading for bird signatures, and recognize specific flight behaviors (e.g., hovering, linear flight, evasive maneuvering). The radar data preprocessing pipeline 310 may assign a tracking ID for each detected object (e.g., each bird or flock). Sequence assembly may group sequential radar returns into bird tracks, and the pipeline may track multiple targets simultaneously (for parallel processing) and handle occlusions or partial detections via interpolation.

The processed data is provided to a spatiotemporal AI model 315, which is a transformer-based model in some implementations. The model 315 analyzes the preprocessed spatial-temporal radar data to determine the risk level and estimate current and future trajectories. The spatiotemporal processing may include positional encoding (e.g., encoding spatial markers, temporal context, and/or radar signature features), a temporal multi-head self-attention mechanism that analyzes motion sequences to identify complex flight patterns, and a set of transformer encoder blocks to extract flight pattern features by analyzing sequential radar data for trajectory pattern recognition. The positional and temporal encoding of some implementations embeds spatial and temporal context to each data point in order to create a unified time-sequenced feature representation and learn time-dependent movement behaviors, and may encode velocity and RCS data as additional feature channels. The transformer encoder blocks of the neural network, in some implementations, are deep learning layers that apply multi-head attention mechanisms to focus on temporally and spatially relevant portions of the radar data sequence, enabling the AI to learn evolving bird trajectories and behaviors over time. In some implementations, the spatiotemporal AI processing also detects inter-object relationships such as flock coordination. This component of the AI can detect motion patterns, recognize flocking behaviors, and identify anomalies such as sudden directional changes. Additional encoder layers may analyze inter-object relationships to detect coordinated flock behaviors or anomalous flight patterns indicative of potential threats. The transformer-based model of some implementations analyzes a sliding window of radar data sequences (e.g., the last 10-20 seconds of movement data, or longer windows for extended prediction) and performs sequence analysis to identify trajectories, bird/flock classification, and behavioral pattern recognition.

In some implementations, the radar system may capture wing Doppler signatures that reflect the characteristic wingbeat patterns of different bird species. Different species may have distinct wingbeat frequencies and patterns that create identifiable Doppler signatures in the radar return signal. For example, larger birds such as geese or herons may exhibit slower, more pronounced wingbeat signatures, while smaller birds such as starlings or swallows may exhibit faster, more rapid wingbeat patterns. These wing Doppler signatures, along with other parameters such as flight speed, altitude, radar cross-section, and estimated weight, may be used to estimate species type or species category. In some implementations, precise species identification may not be required; rather, the system may use the combination of radar-derived parameters to classify birds into general categories (e.g., large birds, small flocking birds, raptors) that inform the selection of appropriate deterrence strategies. In some implementations, species classification models may be trained using video and image data of different bird species in addition to radar data, enabling the system to correlate visual characteristics with radar signatures. The system may also connect to external bird identification databases or APIs, such as eBird, to obtain information about species commonly found at or near specific deployment locations, allowing the system to prioritize species-specific profiles relevant to the local avian population. The species estimation derived from wing Doppler signatures and other radar parameters may be provided to the deterrence decision engine to enable species-specific deterrence parameter selection. As used herein, radar signature characteristics may include one or more of radar cross-section (RCS) values, wing Doppler signatures reflecting wingbeat patterns, flight speed, altitude, estimated weight, and other parameters derivable from radar data that may be used to identify or classify avian species or species categories.

The AI model generates its output 320 (e.g., via multi-task heads of the spatiotemporal AI model). In some implementations, the output may include multiple attention heads for trajectory prediction and risk assessment. Species identification may involve estimating species and size via RCS data. Flight path prediction may include predicted bird (or flock) movement paths and ETAs to designated zones, as well as the likelihood of birds entering hazardous areas. In some implementations, the system may predict positions 30, 60, or even 120 seconds ahead. Proximity and risk scoring may include assignment of a threat level (e.g., low, medium, or high) to each tracked identifier (each bird or flock). The output may also include trajectory prediction for an upcoming time period (e.g., the next 5, 10, 30, 60, or 120 seconds), as well as risk scores and movement probabilities. In some implementations, the trajectory prediction attention head outputs predicted bird movement paths and ETAs to critical zones. The risk assessment attention head may classify threat levels based on predicted trajectories and proximity to hazardous zones (e.g., runways). Risk scores may be based on trajectory intersection with hazardous zones, species and flock size, and speed and altitude of the birds.

In some implementations, threat detection is based on determining whether there is an intersection between a predicted avian flight path and a defined protected corridor. The protected corridor may correspond to a takeoff and landing corridor at an airport, or any other airspace region designated for protection. The system may define the spatial boundaries of the protected corridor and continuously evaluate whether predicted bird trajectories intersect with this corridor. If the prediction model determines that there is any possibility of overlap between the bird's predicted flight path and the protected corridor, the bird or flock may be classified as a threat. In some implementations, the protected corridor may be configured as a fixed region based on historical flight path data, such as aircraft approach and departure paths that remain consistent over time. In other implementations, the protected corridor boundaries may be dynamically adjustable based on operational requirements or changing conditions at the deployment site.

In some implementations, the trajectory prediction process may involve a two-step approach. First, the system generates an initial trajectory prediction based on standard physics-based models, using the bird's current position, velocity, heading, and known flight dynamics for the estimated species. The physics-based models may include kinematic equations that extrapolate future positions based on current position, velocity, and acceleration vectors. In some implementations, the physics-based models may also account for gravitational effects on flight trajectory, aerodynamic principles related to lift, drag, and thrust characteristics for different bird species and sizes, and environmental factors such as wind speed and direction that may affect flight path. Species-specific flight envelope constraints may also be incorporated, such as typical cruising speeds, turning radii, climb and descent rates, and altitude preferences for the estimated species. This initial prediction provides a baseline estimate of where the bird or flock will be at future time points, such as 30, 60, or 120 seconds ahead. Second, the AI model applies learned corrections to this initial prediction based on patterns observed in historical radar data and species-specific behavioral models. The AI correction may account for factors that standard physics-based models may not capture, such as species-specific turning tendencies, flock behavior dynamics, environmental influences (e.g., wind patterns, terrain features), and time-of-day behavioral patterns. As new radar data arrives, the system continuously updates both the initial prediction and the AI correction, refining the predicted trajectory in real-time. The AI may compare its predicted trajectory against the actual observed trajectory and use the difference (prediction error) to further refine its correction model. This two-step approach may enable more accurate long-range predictions compared to purely physics-based or purely AI-based approaches alone. The continuous self-correction may be particularly beneficial for predicting the trajectories of flocks, which may exhibit complex collective behaviors that are difficult to model with standard physics alone.

Next, the AI core performs AI decisions and role assignment logic 325. This logic of the AI core, in some implementations, assigns turrets based on proximity to the threat, performs risk level matching, and performs load balancing between distributed turrets. In some implementations, the central AI node disseminates threat profiles (location, trajectory, risk level, predicted path) to all turret nodes in the area. If a risk is classified as medium or high, the central AI system sends activation commands to nearby turrets. The level of risk (low, medium, or high) may correlate to the number of deterrent nodes used in the deterrence strategy. For instance, a low-risk threat might result in no action, a medium risk threat could result in a single warning deterrent action, and a high-risk threat could result in a full multi-turret deterrent action. If multiple deterrent nodes are involved, coordination between these multiple deterrent nodes is implemented in some implementations. The central AI core directs the deterrence activation, specifying for the AI-enabled turret nodes to emit sound beams and dynamically adjusts the direction of these beams based on ongoing tracking. The sound beam is directed in front of the birds based on AI-predicted future trajectory, with appropriate sound decibel (dB) levels to safely alter the birds' flight path and prevent entry into hazardous zones. Based on the threat classification and risk prediction, a deterrence decision engine may select an optimal deterrent type if multiple different deterrence types are available (e.g., sound/LRADs, lights, lasers), determine the intensity and timing based on the threat category, and adjust the response dynamically using feedback loops. In some implementations, the system outputs specific deterrence parameters including deterrence type, directional targeting parameters (e.g., azimuth and elevation), frequency and intensity (e.g., dB) that may be adjusted for different species, and activation timing and duration.

In some implementations, the trajectory prediction process may employ a multi-horizon prediction architecture in which the prediction method varies by forecast horizon. For short-horizon prediction, such as approximately 1 to 10 seconds ahead, the system may rely primarily on live kinematic radar tracking, including current position, velocity, heading, altitude, acceleration, turn rate, and recent motion history. In this range, the predicted future position may be relatively precise because the bird's motion remains strongly correlated with its current observed state. The short-horizon prediction may involve the two-step approach mentioned above. First, the system generates an initial trajectory prediction based on standard physics-based models, using the bird's current position, velocity, heading, and known flight dynamics for the estimated species. The physics-based models may include kinematic equations that extrapolate future positions based on current position, velocity, and acceleration vectors. In some implementations, the physics-based models may also account for gravitational effects on flight trajectory, aerodynamic principles related to lift, drag, and thrust characteristics for different bird species and sizes, and environmental factors such as wind speed and direction that may affect flight path. Species-specific flight envelope constraints may also be incorporated, such as typical cruising speeds, turning radii, climb and descent rates, and altitude preferences for the estimated species. Second, the AI model applies learned corrections to this initial prediction based on patterns observed in historical radar data and species-specific behavioral models. The AI correction may account for factors that standard physics-based models may not capture, such as species-specific turning tendencies, flock behavior dynamics, environmental influences (e.g., wind patterns, terrain features), and time-of-day behavioral patterns.

For mid-horizon prediction, such as approximately 10 to 60 seconds ahead, the system may supplement kinematic tracking with behavior-aware modeling. At this stage, prediction may not be based only on current motion extrapolation, but also on learned tendencies associated with bird type, flocking behavior, approach angle, maneuver patterns, and proximity to the protected area. In other words, the system may combine motion-state prediction with learned behavioral inference. The behavior-aware modeling may account for species-specific flight characteristics, such as the tendency of certain species to circle or loiter before landing, the likelihood of flock splitting or merging behaviors, and typical responses to environmental features such as bodies of water, tree lines, or structures. The mid-horizon prediction may also consider the bird's or flock's apparent intent based on approach angle and heading relative to the protected zone, enabling the system to assess whether the detected avian activity is likely to enter the protected corridor.

For longer-horizon prediction, such as approximately 60 to 120 seconds ahead, the system need not be limited to predicting a single exact future point. Instead, the system may generate a probabilistic future corridor, occupancy envelope, or protected-zone incursion forecast. This means the system predicts where the bird or flock is most likely to travel, what protected zones it is likely to enter, and at what expected time, even as precise point-position certainty decreases at longer horizons. The probabilistic forecast may be expressed as a spatial envelope or corridor representing the range of likely future positions, along with associated probability values and expected timing for potential incursion into protected zones. This approach acknowledges that prediction uncertainty increases with forecast horizon while still providing actionable information for proactive deterrence planning. Accordingly, the system may support precise short-horizon track prediction, behavior-conditioned mid-horizon trajectory prediction, and probabilistic long-horizon path-envelope or incursion forecasting. As new radar data arrives, the system continuously updates predictions across all horizons, refining the predicted trajectory in real-time. The AI may compare its predicted trajectory against the actual observed trajectory and use the difference (prediction error) to further refine its correction model. This continuous self-correction may be particularly beneficial for predicting the trajectories of flocks, which may exhibit complex collective behaviors that are difficult to model with standard physics alone.

In some implementations, rather than fully centralized deterrence control, the distributed AI-enabled turret nodes 330 perform local role confirmation (e.g., lead, support, or observer). The turret nodes 330 may execute a turret coordination algorithm that negotiates response roles using a distributed protocol. This protocol assigns priority rankings based on proximity to the predicted trajectory, angle of the potential threat, and current and/or predicted future system load. If necessary (e.g., for a coordinated response to large flocks), lead turret selection is performed. The turret coordination algorithm may also have a fallback mechanism in case of communication loss, so that each turret can act autonomously if isolated. In addition, the distributed turret nodes 330 may perform final deterrence decision processing. In some implementations, the lead turret implements the primary deterrence action, support turrets implement secondary deterrence actions in case of trajectory deviation or partial deterrence, and observer turrets monitor bird reaction and provide feedback. The distributed protocol may include a conflict resolution mechanism (e.g., in case multiple different turrets identify themselves as the lead). In some implementations, the conflict resolution mechanism may use the priority rankings as a deterministic tie-breaker, such that when multiple turrets propose themselves as lead, the turret with the highest priority ranking based on proximity, angular position, and system load factors may be selected. If priority scores are equal or within a predefined threshold, a secondary tie-breaker may be employed, such as selecting the turret with the lowest node ID. In some implementations, the mechanism may also consider timestamps of role proposals, where the earliest valid proposal may win when other factors are equivalent. Once roles have been negotiated, the turrets may use inter-turret communication to share the final role assignments. The local AI processing at each turret may include localized threat assessment, which verifies bird trajectory relative to turret position, compares with stored AI patterns for accuracy, and adjusts risk assessment using historical engagement data. Local role assessment may evaluate the turret's proximity to the predicted trajectory and hazardous zone, current operational status and readiness, and ability to respond within the projected timeline. Local role assessment may also include determination of available resources, whether the turret has the best acoustic coverage, a line-of-sight check, assessment of current load (e.g., whether the turret is responding to another active threat), and a redundancy check. The assignment of different roles in real time enables the AI to optimize the deterrence strategy based on live and forecasted threat data.

In some implementations, the self-correction mechanism may be described as a continuous receding-horizon update loop. Each time a new radar update is received, the system compares the previously predicted target state against the newly observed target state. The difference between those states is used to refine the estimated state of the bird or flock, the projected trajectory, the uncertainty bounds of the forecast, and the confidence weighting of the underlying predictive model. This may be implemented using recursive state-estimation techniques, Kalman-style filtering, Bayesian updating, adaptive model weighting, or other online correction mechanisms. In some implementations, the system uses rolling prediction windows in which each newly received radar update is assimilated to revise the predicted trajectory, uncertainty bounds, and expected protected-zone incursion timing. This allows the system to continuously adapt when birds bank, climb, descend, split as a flock, or respond to deterrence. The predictive logic is therefore not static; it is continuously refined based on live observed movement.

The AI turret nodes then command the physical LRAD turrets and perform deterrence execution 335. These commands specify, in some implementations, directional beam targeting, frequency and intensity configuration, and duration. The turrets selected to handle a given threat activate sound deterrence (e.g., LRAD bursts) in a synchronized manner to maximize effect and avoid redundancy. In some implementations, the turrets adjust direction, frequency, and power dynamically based on AI-predicted flight paths and ongoing radar feedback. Some embodiments direct the sound beam in front of the birds based on AI-predicted future trajectory, with appropriate dB levels to safely alter the birds' flight path and prevent entry into hazardous zones. The central AI core and/or the distributed AI modules at the turrets may control these deterrence actions. In some implementations, the lead turret activates the primary deterrent (e.g., an LRAD beam aimed in front of the AI-predicted flight path), while support turrets prepare for secondary activation if appropriate (e.g., if the threat persists). Some support turrets may provide additional deterrence while others await in assist mode. Observer turrets typically do not initially take any action. The local deterrence decision-making determines the deterrence parameters to use, which may depend on the type of deterrent node. These parameters may include the direction and angle towards the future predicted location of the bird or flock, and appropriate intensity levels based on flock size and species. The parameters may be adjusted dynamically if the bird or birds change course. In some implementations, a specific command structure is used for sending deterrence activation commands to the turrets, which may include fields such as: command type (activate, adjust, or deactivate), target coordinates (predicted bird position, ETA), aim parameters (azimuth, elevation angles for directional targeting), frequency profile (sound frequency in Hz based on species and context), intensity (sound level in dB), duration (activation time window), adaptive mode (enable or disable automatic adjustment based on feedback), safety compliance flag, environmental data (wind speed, direction, background noise level), flock characteristics (estimated bird type, number of birds, bird size), and response feedback (bird reaction status). Some implementations require acknowledgment from the turret to confirm readiness.

Finally, the radar and AI provide feedback 340. This feedback loop monitors bird reaction to deterrence and updates AI models for continuous learning. The AI models continuously update risk assessments and predicted trajectories based on turret actions and real-time radar feedback. The system maintains adaptive deterrence to dynamically respond to changing bird behaviors in some implementations. In some implementations, an AI subsystem referred to as a feedback monitoring unit monitors bird and flock responses to deterrence and adjusts deterrence strategies accordingly. The feedback monitoring unit may be implemented as a software module executing on the central AI processing node, as a distributed component with portions executing on both the central AI processing node and the edge AI modules at the turret nodes, or as a dedicated processing component. This AI subsystem monitors bird and flock reactions via real-time radar updates. If a bird (or birds) does not change course (e.g., remains on a collision path), the AI dynamically adjusts the deterrent parameters (e.g., by increasing intensity within safety limits and/or shifting targeting direction), allowing for continuous system adaptation to changing bird behaviors. In some implementations, adaptive logic prevents habituation by varying the stimuli (e.g., alternating deterrent types, modulating signals). Examples of feedback and algorithmic response may include: birds remain on collision path: increase intensity, adjust angle, and/or change deterrent type; birds show partial deviation: continue with modulated pulses, adjust based on reaction speed; birds fully divert from hazardous zone: cease deterrence, monitor until fully cleared; birds return or re-approach after deterrence: reinitiate deterrence with adjusted patterns and parameters. The turret AI may log engagement success and/or failure, adjust local AI weightings based on outcomes, and send updates to the central AI processor for system-wide optimization in some implementations. The ability to adapt the response allows for dynamic adjustment as bird behavior evolves. In some implementations, an adaptive AI model retraining loop based on field data uses continuous collection of real-world deterrence outcomes and retrains AI models with updated bird response data to improve accuracy. Deterrence parameters may be adjusted based on AI learning from previous bird behavior, and habituation may be prevented by generating evolving deterrence strategies. Once a threat is resolved, some implementations cease deterrent activation and log activation parameters as well as bird responses for auditing (e.g., for regulatory compliance) and further AI model training.

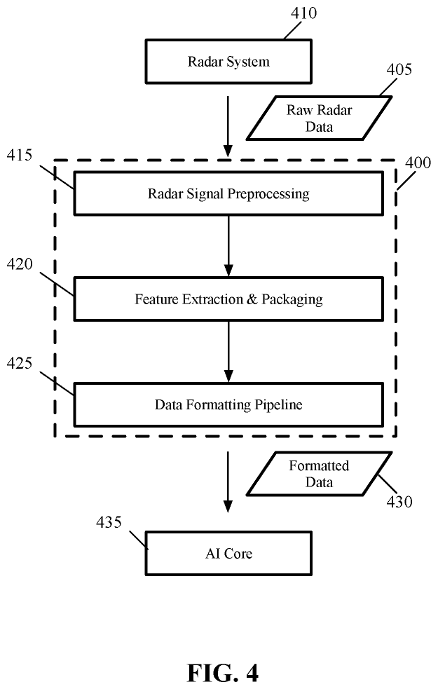

FIG. 4 illustrates a radar data handling and preprocessing operational flow 400, in accordance with one or more embodiments. The data processing pipeline 400 is designed for receiving, parsing, normalizing, and preparing real-time radar data for AI-based analysis that focuses on bird detection, classification, trajectory prediction, and risk assessment. The purpose of the pipeline is to process raw radar inputs into structured data for AI analysis, generate high-quality time-sequenced data optimized for spatiotemporal modeling, enable accurate bird detection, species estimation, and flight path tracking, and ensure low-latency real-time data availability for AI inference and turret control.

As shown, raw radar data input 405 is provided from a radar system 410 to the preprocessing pipeline 400. In some implementations, the pipeline 400 also receives data about environmental noise (e.g., background signals, atmospheric noise, and clutter). The radar system 410, in some implementations, is an avian radar system that captures real-time spatial and temporal bird data. The radar system 410 captures raw radar reflections from avian radar sensors, extracts object positions, velocity, heading, and RCS signature, logs timestamped data for temporal analysis, and applies initial calibration to ensure accuracy. The raw radar data provided to the preprocessing pipeline 400, in some implementations, includes positional coordinates (x, y, z), RCS values, velocity (speed and direction) vectors, and timestamps. The pipeline includes a data ingestion interface, in some implementations, that normalizes coordinate frames and units for system consistency.

A radar signal preprocessing module 415 performs noise reduction and signal filtering in some implementations. This is a pipeline for cleaning, filtering, and structuring the raw radar data. In some implementations, the preprocessing module 415 removes environmental interference (e.g., weather, terrain, clutter), isolates moving objects from stationary background noise, and normalizes signal intensity across multiple radar scans. Other objects may be filtered out via RCS signature matching, velocity and flight pattern heuristics, and noise reduction algorithms. In some implementations, the preprocessing module 415 removes duplicate or spurious detections.

Next, the preprocessing pipeline 400 performs feature extraction and packaging 420. Feature extraction, in some implementations, identifies bird-specific RCS signatures, computes object size, altitude, speed, acceleration, and heading for bird signatures, recognizes specific flight behaviors (e.g., hovering, linear flight, evasive maneuvering), and assigns a tracking ID for each detected object (e.g., each bird or flock). Sequence assembly groups sequential radar returns into bird tracks, and the pipeline may track multiple targets simultaneously (for parallel processing) and handle occlusions or partial detections via interpolation.

A data formatting pipeline 425 of the preprocessing pipeline 400 performs data encoding (feature encoding) and formatting to generate AI-ready formatted data 430. The data encoding includes spatial and temporal encoding that embeds spatial coordinates (x, y, z) with precise timestamps and associates object IDs with historical flight paths. Each data point, in some implementations, is encoded with a spatial position, a velocity vector, a temporal encoding, and radar signature features (e.g., RCS and/or size estimate). The formatting pipeline 425 transforms the data into an AI-compatible input format (e.g., structured sequences for consumption by the AI model). This may include, in some implementations, converting raw signals into a structured tensor format for neural network processing, encoding extracted features for deep learning processing, and compressing and packaging data for real-time transmission to the AI model.

The formatted data 430 is then handed off to an AI core 435. Some implementations store the structured sequences in a fast-access local cache (e.g., short-term storage for AI access and failover scenarios) and/or feed data to the AI model(s) via a secure, low-latency interface designed for real-time operation. The data is provided continuously in some implementations by maintaining rolling data buffers to allow the AI core 435 to analyze recent time windows (e.g., a rolling window of the last 10-30 seconds of movement), allowing the AI to perform up-to-the-second prediction. The formatted output data 430 of some implementations includes time-stamped positions sequenced for trajectory analysis, sequenced velocity vectors, RCS profiles (radar signature features), temporal encoding for spatiotemporal modeling, and track IDs (unique identifiers for each bird or flock, which may be persistent for ongoing classification and deterrence monitoring).

The preprocessing pipeline 400 integrates into the overall deterrence system by directly interfacing with the AI processing unit, securely delivering structured time-sequenced data for trajectory prediction. In some implementations, the formatted data may also be provided directly to AI turret nodes for local decision-making as needed, and feeds into the failover caching layer for autonomous turret mode if turrets lose communication. Some implementations integrate the data processing pipeline into the user interface of the command and control system so that an operator can stay aware of developing situations.

In some implementations, an optional pre-AI risk assessment filter may be employed. This preliminary risk scoring may be based on proximity of tracked birds or flocks to hazardous zones, speed and direction of birds or flocks towards sensitive areas, and/or characteristics of size or flock. This pre-assessment enables the generation of alerts pending AI analysis.

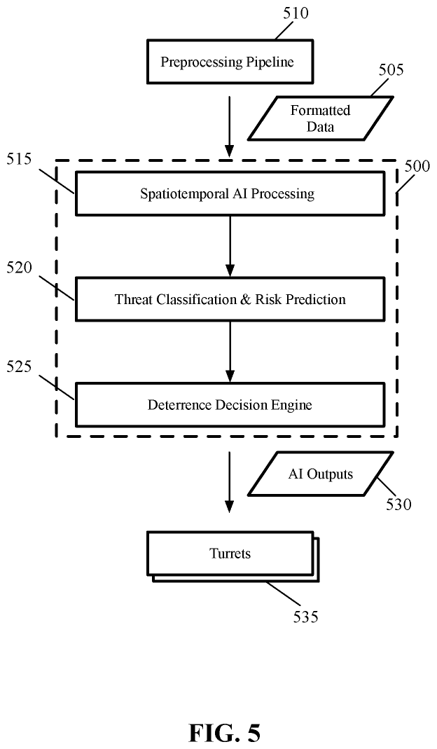

FIG. 5 illustrates an architecture and data flow of a central AI core 500, in accordance with one or more embodiments. The central AI core 500 performs real-time avian threat detection, trajectory prediction, and adaptive deterrent control. The architecture is designed to process radar data streams to detect and classify birds and flocks, predict future bird movements to forecast future movements toward hazardous zones, classify risk levels and identify high-threat situations, generate actionable outputs for distributed AI-turret systems (e.g., to generate deterrent control parameters for turret and LRAD systems), and to provide adaptive feedback to adjust deterrence strategies in real-time.

From the preprocessing pipeline 505, the AI core 500 receives formatted and encoded radar data 510 (e.g., the output of the pipeline 400 described above). This data can include radar positional data (e.g., real-time x, y, z coordinates of birds and flocks), radar temporal sequences (e.g., time-series of positional data to analyze movement patterns), RCS data (signature data used for species estimation and size classification), and velocity and direction vectors of bird movement. The AI core 500 may also receive historical trajectory data (cached data used for training and real-time comparison).

The AI core 500 initially performs spatiotemporal AI processing 515 on this data (e.g., using a transformer-based neural network structure with multi-head self-attention). This processing may include positional encoding (encoding spatial markers, temporal context, and/or radar signature features), a temporal multi-head self-attention mechanism that analyzes motion sequences (to analyze complex flight patterns), and/or a set of transformer encoder blocks to extract flight pattern features (analyzing sequential radar data for trajectory pattern recognition). The positional and temporal encoding embeds spatial and temporal context to each data point to create a unified time-sequenced feature representation and learn time-dependent movement behaviors, and may encode velocity and RCS data as additional feature channels. The transformer encoder blocks are deep learning layers that apply multi-head attention mechanisms to focus on temporally and spatially relevant portions of the radar data sequence, enabling the AI to learn evolving bird trajectories and behaviors over time. The spatiotemporal AI processing 515 may also detect inter-object relationships such as flock coordination. This component can detect motion patterns, recognize flocking behaviors, and identify anomalies such as sudden directional changes (e.g., with additional encoder layers that analyze inter-object relationships to detect coordinated flock behaviors or anomalous flight patterns indicative of potential threats).

Next, the threat classification and risk prediction component 520 operates on the data generated by the spatiotemporal processing component 515. This component may include multiple attention heads for trajectory prediction and risk assessment. The threat classification and risk prediction component 520 assigns a threat level (e.g., low, medium, or high) to each tracked identifier (each bird or flock), predicts the trajectory for each tracked identifier for an upcoming time period (e.g., the next 5, 10, 30, 60, or 120 seconds), and outputs risk scores and movement probabilities. The trajectory prediction attention head outputs predicted bird (or flock) movement paths and ETAs to protected zones as well as the likelihood of birds entering these hazardous areas. The risk assessment attention head classifies threat levels based on the predicted trajectories and the proximity of the tracked objects to hazardous zones (e.g., runways). The risk scores can be based on trajectory intersection with the hazardous zones, the species and flock size of the tracked birds, and the speed and altitude of the birds.

Based on the threat classification and risk prediction (e.g., if the predicted risk surpasses a pre-set threshold), the deterrence decision engine 525 selects a suitable deterrent type if multiple different deterrence types (e.g., sound/LRADs, lights, lasers) are available, determines the intensity and timing based on the threat category, and adjusts the response dynamically using feedback loops. Some implementations output specific deterrence parameters, including the deterrence type, directional targeting parameters (e.g., azimuth and elevation), frequency and intensity (e.g., dB) that may be adjusted for different species, and the activation timing and duration. These parameters (and/or commands carrying the parameters) may be generated by an activation attention head of the neural network. The dynamic adjustment involves an adaptive feedback loop that analyzes bird responses from real-time radar updates and adjusts the future predictions and deterrent recommendations dynamically.

The AI core 500 outputs various data 530, including predicted trajectories (future flight paths, spatial vectors, and ETA to hazard zones), risk classifications (e.g., threat levels), deterrent control parameters (e.g., direction, frequency, intensity, and timing recommendations for turrets), and actionable command packages to the turrets (structured command data packets for distributed turret activation). The turrets 535 receive the output data 530 from the AI core 500 and execute deterrence actions based on the commands and parameters provided.

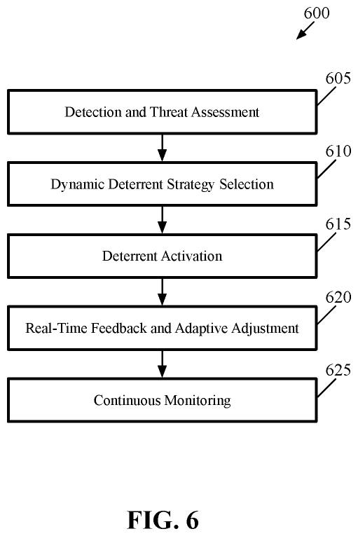

FIG. 6 illustrates an operational flow 600 of a wildlife deterrence system with dynamic adaptive deterrence, in accordance with one or more embodiments. This operational flow 600 relates to the selection, configuration, and activation of deterrents such as LRAD (Long-Range Acoustic Devices), lights, and lasers based on AI-predicted trajectories, species identification, and risk assessments. These deterrent activation algorithms are designed to select a suitable deterrent type for each detected threat, dynamically configure deterrent parameters (e.g., sound frequency, direction, intensity), align deterrent actions with AI-predicted bird trajectories for proactive intervention, and adapt deterrent responses based on real-time feedback on bird behavior. The AI models executing in the central core can provide trajectory forecasts for precise targeting, species identification for deterrent type and parameter optimization, risk scoring to prioritize threats, and feedback analysis to refine deterrence models over time.

The operation flow 600 begins with detection (e.g., via radar or other inputs) and threat assessment 605 (e.g., by the AI core). In some implementations, the radar system detects birds and flocks, transmitting real-time data to the AI engine, which analyzes spatial and temporal patterns to classify threats and predict flight paths. The AI engine generates predicted trajectories and ETA for each bird or flock, estimations of species and flock size, and risk level classifications (e.g., low, medium, and high). This AI-predicted trajectory-based deterrence enables proactive, targeted interventions before threats materialize.

Next, the dynamic deterrent strategy selection 610 (which may also be performed by the AI core) analyzes predicted trajectories, species, flock size, and behavior to determine the suitable deterrent type and parameters for a given threat. These deterrent types can include LRAD for long-range acoustic deterrence as well as lights or lasers for visual disruption (which may be a species-specific determination), or other non-harmful and/or non-lethal mechanisms capable of directional operation and variable output. The deterrence selection logic, in some implementations, considers species sensitivity databases and regulatory constraints. These parameters can include the direction (e.g., the azimuth and elevation, to aim the deterrence ahead of the AI-predicted trajectory), the sound frequency (e.g., in Hz, selected from species-specific response profiles) and intensity (e.g., in dB, which may be set according to species sensitivity and threat level) for LRAD deterrence. In addition, the parameters can include the duration (e.g., based on estimated ETA to hazard zone and effectiveness of prior attempts) and pulse modulation (e.g., varied pulse patterns to avoid bird habituation). A deterrent controller (e.g., a module running at the central computing device(s) along with the AI core) provides the configuration data to the deterrent devices.

In some implementations, different deterrence strategies may be used for different species. For large birds (e.g., geese, herons, cranes) detected based on high RCS signature, which tend to be slower moving with higher flight altitude, a primary deterrence strategy of directional LRAD at 90-110 dB may be used, with pre-recorded distress calls specific to the detected species. Some implementations use multi-node coordination to form a deterrence perimeter. For these large birds, if the initial deterrence fails, the intensity can be increased to 115 dB with alternative distress call variations, and the frequency can be adjusted to a pre-determined alternative based on species response history.

For small birds and flocking species (e.g., starlings, swallows), which may be detected as a high-density cluster with erratic movement and tend to be fast-moving with unpredictable flight paths, a primary deterrence strategy of broad-area LRAD at 70-90 dB with rapid frequency modulation may be used, using multi-directional activation from multiple turrets. The dynamic variation of pre-trained sound frequencies may be used to disrupt flock behavior. For these small birds, if the initial deterrence fails, different sound frequencies may be used. An alternative pre-trained sound frequency may be selected (higher or lower based on AI response mapping), and the frequency cycling pattern may be adjusted dynamically.

For raptors and birds of prey (e.g., eagles, hawks, falcons), which may be identified based on a solitary flight pattern (often linear with gliding motion) at high altitude and tend to have a distinct radar signature with lower density presence, a primary deterrence strategy of targeted LRAD at 100-115 dB may be used, with predator call playback to simulate competing raptors and induce retreat. Adaptive noise variation to disrupt flight focus may also be used. For these raptors, if the initial deterrence fails, the acoustic intensity can be increased and/or the sound can be switched to a different pre-trained raptor distress call or predator call. In addition, AI-controlled alternating frequency shifts from known effective patterns may be introduced.

The next operation in the flow 600 is the deterrent activation 615, as per the configured parameters. The deterrent devices are activated in a targeted manner based on the commands output by the AI core. In some implementations, the turret controller at each of the deterrent devices receives the commands output by the core, verifies safety compliance, and then manages the targeting and activation of the physical deterrent. This involves the aiming of sound beams or light pulses ahead of the predicted bird path(s) to safely redirect the flight trajectory, using the appropriate intensity level and duration calculated by the AI core to ensure non-harmful and/or non-lethal but effective deterrence. Some implementations also monitor the system status to ensure safety compliance (e.g., staying within non-harmful and/or non-lethal intensity limits). The dynamic selection of deterrence types and fine-grained parameter control combines sound, light, and other methods for maximum flexibility while optimizing effectiveness of the deterrence and minimizing habituation of the local bird populations.

Next, the deterrent operations having been implemented, real-time feedback and adaptive adjustment 620 is performed. In some implementations, an AI subsystem referred to as a feedback monitoring unit monitors bird and flock responses to deterrence and adjusts deterrence strategies accordingly. The feedback monitoring unit may be implemented as a software module executing on the central AI processing node, as a distributed component with portions executing on both the central AI processing node and the edge AI modules at the turret nodes, or as a dedicated processing component. This AI subsystem monitors bird and flock reactions via real-time radar updates. If a bird (or birds) does not change course (e.g., remains on a collision path), the AI dynamically adjusts the deterrent parameters (e.g., by increasing intensity within safety limits and/or shifting targeting direction), allowing for continuous system adaptation to changing bird behaviors. In some implementations, adaptive logic prevents habituation by varying the stimuli (e.g., alternating deterrent types, modulating signals).

Finally, the wildlife deterrence system performs continuous monitoring 625. In some implementations, the system maintains real-time updates on bird positions and behaviors, adjusting deterrent strategies as necessary until the threat is mitigated. Once the threat is resolved, some implementations cease the deterrent activation and log the activation parameters as well as the bird responses for auditing (e.g., for regulatory compliance) and for further AI model training. The autonomous operation reduces the need for human intervention and increases reliability and scalability of the system.

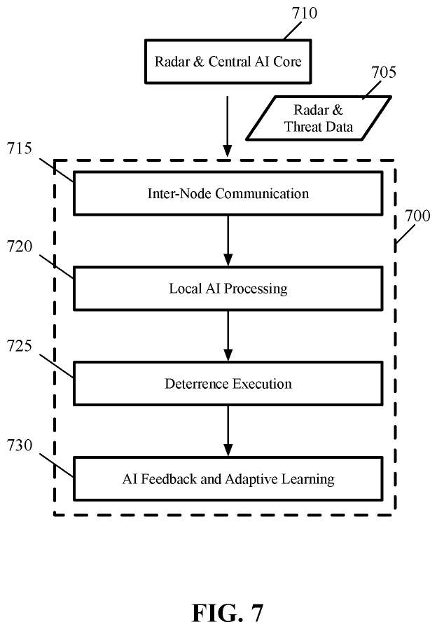

FIG. 7 illustrates an architecture and data flow of a single AI-enabled turret 700, in accordance with one or more embodiments. These turrets operate in accordance with a distributed coordination protocol designed to enable autonomous coordination among multiple deterrent turrets in the wildlife deterrence system. The protocol leverages AI-predicted bird trajectories to enable proactive and dynamic deterrent deployment, optimizing coverage and minimizing risk. The purpose of this coordination protocol is to define how AI-enabled turret nodes communicate and coordinate roles based on AI-generated risk assessments and predicted bird trajectories. The protocol ensures synchronized deterrence actions and autonomous operation under both connected and failover scenarios. Distributed coordination can eliminate both redundant turret activations and blind spots.

As shown, the AI-enabled turret node 700 receives radar and threat data 705 from the radar system and central AI core 710. In some implementations, each turret node receives from the radar spatial and temporal bird data (e.g., x, y, z coordinates, velocity and heading vectors, and RCS signature information). The central AI core has performed its trajectory prediction and risk classification analysis and provides trajectory and/or threat classification information to the turret nodes 700. This information can include the predicted flight path (e.g., as 3D spatial vectors with timestamps), ETA to protected zones, and threat levels (e.g., low, medium, or high).

The turret node 700 engages in inter-node communication 715 via an inter-node communication network that facilitates low-latency, real-time data exchange among turret nodes. This communication 715, in some implementations, involves the exchange of situational awareness updates with other turret nodes. The turret 700 sends its status and engagement confirmation. Furthermore, the turret node 700 coordinates response roles (e.g., leader, support, or observer roles) and synchronizes actions with nearby turret nodes. This inter-node communication can occur throughout the deterrence operation in some implementations (as opposed to specifically prior to the local AI processing).

In some implementations, a specific data packet structure is used for inter-node communication. Data messages sent between turrets may include fields such as: message type (specifies whether the message is for role negotiation, activation command, or status update), node ID (unique turret identifier), timestamp of message generation, predicted trajectory (spatial vectors, ETA, risk level), role proposal (suggested role based on turret's self-assessment), deterrence parameters (direction, frequency, and/or intensity), and observations (bird response data, ongoing status). Different messages may include different subsets of these fields depending on the message type.

Based on the data received from the central AI core, radar system, and/or other turrets, the turret node performs its local AI processing 720. The local AI processing 720 includes, in some implementations, a localized threat assessment as well as local decision-making. The local threat assessment verifies bird trajectory relative to turret position, compares with stored AI patterns for accuracy, and adjusts risk assessment using historical engagement data. The local AI also performs local role assessment to evaluate the turret's proximity to the predicted trajectory and hazardous zone, current operational status and readiness, and ability to respond within the projected timeline. Local role assessment may also include determination of available resources, whether the turret has suitable acoustic coverage, a line-of-sight check, assessment of current load (e.g., whether the turret is responding to another active threat), and a redundancy check. The assignment of different roles in real time enables the AI to optimize the deterrence strategy based on live and forecasted threat data.

The local AI processing 720 engages in various decision-making to determine if local action is warranted, adjust the response based on AI threat classification, and verify if support from other turrets would be beneficial. The turrets, in some implementations, engage in a distributed protocol to negotiate roles based on proximity to the AI-predicted path, angular position relative to bird or flock direction, system load and readiness, and historical effectiveness. Roles may be negotiated as lead, support, and observer. The lead turret implements the primary deterrence action, support turrets implement secondary deterrence actions in case of trajectory deviation or partial deterrence, and observer turrets monitor bird reaction and provide feedback. The distributed protocol may include a conflict resolution mechanism (e.g., in case multiple different turrets identify themselves as the lead). In some implementations, the conflict resolution mechanism may use the priority rankings as a deterministic tie-breaker, such that when multiple turrets propose themselves as lead, the turret with greater priority ranking based on proximity, angular position, and system load factors may be selected. If priority scores are equal or within a predefined threshold, a secondary tie-breaker may be employed, such as selecting the turret with the lowest node ID. In some implementations, the mechanism may also consider timestamps of role proposals, where the earliest valid proposal may win when other factors are equivalent. Once roles have been negotiated, the turrets may use inter-turret communication to share the final role assignments.

The turret 700 then performs its deterrence execution 725. In some implementations, the lead turret activates the primary deterrent (e.g., an LRAD beam aimed in front of the AI-predicted flight path), while support turrets prepare for secondary activation if warranted (e.g., if the threat persists). Some support turrets may provide additional deterrence while others await in assist mode. Observer turrets typically do not initially take any action. The local deterrence decision-making determines the deterrence parameters to use, which may depend on the type of deterrent node. These parameters can include the direction and angle towards the future predicted location of the bird or flock, and appropriate intensity levels based on flock size and species. The parameters can be adjusted dynamically if the bird or birds change course.

While the turret or turrets carry out the deterrence, in some implementations ongoing inter-turret communication shares real-time updates of bird position relative to predicted trajectory (based on radar data) as well as AI adjustments to the predicted path based on updated radar data. The turrets also share deterrence outcome and bird response observations. This ongoing communication enables dynamic coordination during active deterrence events. In some implementations, the handover between turrets is predictive and anticipatory rather than merely reactive. The system prepares the receiving turret before the handing-off turret loses effectiveness, so deterrence continuity is preserved. The predictive handover may proceed through a five-stage sequence: (1) track sharing, in which the handing-off turret shares target state, target identity, predicted path, and current deterrence status with the receiving turret; (2) pre-lock or reservation, in which the receiving turret begins tracking the same target before the handing-off turret disengages; (3) overlap phase, in which both turrets temporarily maintain awareness of their target during a controlled overlap window; (4) authority transfer, in which the receiving turret becomes the primary active deterrence unit while the handing-off turret transitions to secondary or standby status; and (5) confirmation, in which the system verifies uninterrupted tracking and deterrence continuity. The transfer decision may be based on factors such as: the predicted path of the bird enters the receiving turret's preferred engagement envelope; the receiving turret has a better interception angle or safer deterrence orientation; the handing-off turret is approaching a safety boundary, mechanical limit (such as slew or range limits), or lower-effectiveness region; or the orchestration logic determines that engagement authority should shift to maintain uninterrupted deterrence coverage. In some implementations, the receiving turret inherits the current deterrence parameters (such as frequency, intensity, and direction) from the handing-off turret so that it does not have to recalculate parameters from the beginning. During an active deterrence event, the deterrence parameters such as frequency and intensity may be adjusted as the bird's distance from the turret changes, and when handover occurs, the receiving turret inherits parameters that are appropriate for the bird's distance and speed at the moment the bird enters the receiving turret's coverage area, rather than restarting from initial default parameters; and the continuous real-time communication between turrets ensures there is no gap in deterrence coverage during the transition. The inter-turret communication may include real-time status updates such as turret activation status, current targeting direction, and remaining capacity or resources. Bird behavior observations shared among turrets may include whether birds are responding to deterrence, direction of deviation, speed changes, and flock splitting behavior. This shared situational awareness enables the distributed turret network to function as a coordinated system rather than as independent units. In some implementations, the communication latency is kept low to enable real-time coordination during fast-moving threat scenarios.

Finally, the turret 700 performs AI feedback and adaptive learning 730. The turret AI may log engagement success and/or failure, adjust local AI weightings based on outcomes, and send updates to the central AI processor for system-wide optimization in some implementations. The ability to adapt the response allows for dynamic adjustment as bird behavior evolves. Engagement logging may include details such as the deterrence parameters used (frequency, intensity, direction), the species and flock characteristics, the bird's initial trajectory and response trajectory, the time to response, and whether the deterrence was successful. This data may be stored locally and synchronized with the central AI upon reconnection (if in failover mode) or in real-time (if connected). The logged data may be used for AI model retraining to improve future predictions and deterrence recommendations. In some implementations, the system may build and update based on accumulated engagement data. When a similar bird or flock is encountered in the future, the system may immediately apply previously learned effective parameters without repeating the learning process, thereby improving response time and deterrence effectiveness over successive encounters. This continuous learning loop may enable the system to improve its effectiveness over time as it accumulates data regarding which deterrence strategies prove effective for various species, flock sizes, and environmental conditions. The feedback data may also be used for regulatory compliance reporting and auditing purposes.

In some implementations, the system maintains a species-specific deterrence profile database that maps species characteristics to effective deterrence parameters. Each profile in the database may include the species identifier or species category, radar signature characteristics (e.g., typical RCS range, wingbeat frequency signature, flight speed range, altitude preferences), effective deterrence parameters (e.g., frequency ranges, intensity levels, pulse patterns, deterrent types), escalation sequences (e.g., ordered lists of parameter adjustments to try if initial deterrence is unsuccessful), and effectiveness metrics (e.g., historical success rates for each parameter combination). The typical RCS range for a species profile may be derived from accumulated radar observations of that species, representing the expected range of RCS values characteristic of that species or species category. In some implementations, the typical RCS range may be initially populated based on ornithological research data or historical radar data from other deployment sites, and may be refined over time as additional radar observations are collected at a given deployment site.

When a new bird or flock is detected, the system may match the encounter to an existing profile based on features extracted from the radar data, such as RCS signature, flight speed, altitude, flight pattern (e.g., linear, erratic, gliding), and flock density and formation characteristics. In some implementations, flock density may be computed based on the spatial distribution and concentration of radar returns within a detected cluster. For example, flock density may be derived from the number of individual radar returns or tracked objects detected within a defined spatial volume over a given time interval. Higher flock density values may be indicative of small flocking species such as starlings or swallows, which tend to fly in tightly packed formations, while lower flock density values may be indicative of solitary birds or raptors that typically maintain greater separation from other birds. The flock density metric may be used in conjunction with other radar-derived features during the profile matching process to improve species classification accuracy.

In some implementations, the system maintains a species-specific deterrence profile database, which may also be referred to as a deterrence profile library or target-response knowledge base, that maps species characteristics to effective deterrence parameters. The mapping may be described as: observed bird or flock characteristics+context+prior outcomes →selected deterrence strategy and operating parameters. The stored information is not limited to bird identity alone; more importantly, the system stores the response policy that has been effective for similar targets under similar conditions. Each profile in the database may include target classification information such as the species identifier or species category, radar-observable movement features such as typical RCS range, wingbeat frequency signature, flight speed range, and altitude preferences, optional multi-sensor-derived attributes, prior encounter history, deterrence settings previously used, measured success and failure outcomes, confidence values, and contextual tags such as time of day, season, weather, flock size, and airport sub-zone or location within the deployment site. Examples of stored deterrence parameters may include acoustic pattern type, frequency family, pulse duration, modulation pattern, repetition rate, beam dwell time, sweep behavior, lead offset relative to predicted bird direction, escalation sequence, and retry/cooldown logic. The typical RCS range for a species profile may be derived from accumulated radar observations of that species, representing the expected range of RCS values characteristic of that species or species category. In some implementations, the typical RCS range may be initially populated based on ornithological research data or historical radar data from other deployment sites, and may be refined over time as additional radar observations are collected at a given deployment site.

In some implementations, flight pattern characteristics are derived from analysis of sequential radar position data over time, including computing trajectory smoothness, directional consistency, and motion variability metrics. Linear flight patterns may be characterized by consistent heading and velocity with reduced deviation, erratic patterns may be characterized by frequent directional changes and variable velocity, and gliding patterns may be characterized by gradual altitude changes with minimal wingbeat signatures in the radar return. The transformer encoder blocks and multi-head self-attention mechanisms of the spatiotemporal AI model may analyze these sequential radar data points to extract and classify flight pattern features for use in the species matching process. The matching process may use a similarity metric or classification algorithm to identify the closest matching profile in the database.

In some implementations, the profile matching does not depend only on exact species identification. The system may match a new encounter by exact species, species family, behavior class, flock type, learned similarity cluster, or nearest stored response profile. A new encounter can be matched by forming a feature vector or other target representation and comparing it to stored profiles. The features used for similarity determination may include speed, heading, acceleration, turn rate, altitude, climb or descent pattern, approach angle toward the protected zone, flock size and spacing, radar cross-section or size proxy, track smoothness or evasiveness, prior response to deterrence, dwell behavior near protected areas, and environmental context such as wind, time of day, season, or location within the deployment site. In this way, even if the system cannot conclusively identify a bird as a specific species, it can still determine that the observed target behaves sufficiently like a previously encountered class and therefore should begin with the deterrence profile that was effective for that class. From an implementation standpoint, this matching may be performed using nearest-neighbor comparison, clustering, weighted scoring, learned embeddings, probabilistic classification, or other similarity-based selection logic.

If a close match is found, the system may immediately apply the deterrence parameters from the matched profile, bypassing the initial learning phase. Once an effective response profile has been learned and stored, future encounters can initialize from that stored profile rather than beginning from trial-and-error, while still permitting adaptation if conditions differ from those under which the profile was originally learned. If no close match is found (e.g., for a species not previously encountered at the deployment site), the system may apply default deterrence parameters and begin the learning process for a new profile. The default deterrence parameters may be derived from baseline parameter ranges based on general avian behavioral characteristics, such as frequency and intensity ranges that have demonstrated effectiveness across multiple species categories. In some implementations, the default parameters may be selected from a mid-range of the system's operational capabilities, such as a moderate frequency and a moderate intensity level that have proven generally effective for deterring avian activity without being species-specific. The default parameters may also be informed by ornithological research data or historical deterrence data from other deployment sites. In some implementations, system administrators may configure the default deterrence parameters during initial deployment based on the expected avian activity at the site, such as selecting default parameters appropriate for the predominant species categories anticipated at that location.

In such cases, the system monitors the avian response to the default deterrence parameters via real-time radar data. If the initial deterrence is unsuccessful (e.g., the birds do not change course), the system may iteratively explore alternative parameter combinations, such as different frequencies, intensities, angles, pulse patterns, or deterrent types. If no sufficiently similar stored profile exists, the system may create a provisional new profile, test one or more candidate deterrence parameters, measure the outcome, and store the resulting target-response data for future reuse. When a parameter combination successfully causes the desired trajectory change, the system logs the effective parameters along with the radar signature characteristics of the encounter. These logged parameters may form the basis of a new species-specific deterrence profile. In some implementations, the learning process employs reinforcement learning techniques to optimize parameter selection over successive encounters. Effectiveness scores may be assigned to each parameter combination tried, with successful outcomes reinforcing those parameters in the new profile.

The profiles may be updated continuously based on new engagement data, with successful deterrence outcomes reinforcing existing parameter selections and unsuccessful outcomes triggering exploration of alternative parameters. In some implementations, profiles may be shared across deployment sites via transfer learning, wherein the data transferred between sites may include species-specific deterrence profiles as well as species classification models trained on video and image data of bird species collected at other deployment sites, enabling a new deployment to benefit from deterrence data collected at other sites. The transfer learning mechanism may involve fine-tuning a global AI model on a localized dataset specific to a particular deployment site. The data transferred between sites may include the species-specific deterrence profiles comprising effective deterrence parameters, radar signature characteristics, and effectiveness metrics accumulated at other deployment sites. A receiving site may use the transferred profiles as a starting point and then refine them based on the local radar environment and local species behaviors observed at that site. The local radar environment may comprise site-specific characteristics such as terrain features and topography that affect radar reflections, local weather patterns and atmospheric conditions, background clutter characteristics specific to the deployment location, radar calibration parameters for the local installation, and any site-specific interference patterns. This approach may enable faster deployment and higher initial deterrence effectiveness at new sites compared to systems that learn effective parameters from scratch.

The profile database may be stored at both the central AI node and cached at individual turret nodes for use during failover operation. In some implementations, the species-specific deterrence profile database may be implemented as a relational database, a key-value store, a document database, or other suitable data structure. The database may be indexed by species identifier or species category to enable efficient retrieval of profiles during real-time operation. In some implementations, the database may also be indexed by radar signature characteristics, such as RCS range or wingbeat frequency signature, to enable rapid profile matching based on observed radar data without requiring prior species classification. The profile database may be initially populated with baseline profiles derived from ornithological research data, historical deterrence data from other deployment sites, or default parameter ranges based on general avian behavioral characteristics. In some implementations, the system may connect to external bird identification databases or APIs to obtain species information for pre-populating profiles relevant to the expected avian activity at a given deployment site. The profile database may be maintained and updated over time through periodic synchronization between the central AI node and the turret node caches. In some implementations, the synchronization may occur at regular intervals, upon reconnection after a communication disruption, or when significant profile updates are available. Profile versioning may be employed to track changes to profiles over time and to resolve conflicts when multiple turrets update the same profile based on independent deterrence encounters. In some implementations, conflict resolution may involve merging effectiveness metrics from multiple sources, selecting the profile version with the highest effectiveness score, or applying a weighted average of parameters based on the number of encounters contributing to each version.

In some implementations, when no matching species-specific deterrence profile is found for a detected bird or flock, the system initiates deterrence with an initial frequency and an initial intensity level and monitors the avian response to determine whether the deterrence is effective. In some implementations, the initial frequency and initial intensity level may be the lowest frequency and lowest intensity level from available deterrence parameter ranges, enabling the system to start with minimal stimulus and escalate only as needed. In other implementations, the initial values may be selected based on other criteria, such as mid-range values from the system's operational capabilities or values informed by general avian behavioral characteristics. If the initial deterrence does not achieve the desired trajectory change, the system may iteratively increase at least one of the frequency and the intensity level and continue to monitor for the desired trajectory change. When the desired trajectory change is detected, the system stores the frequency and intensity level that achieved the desired trajectory change as effective deterrence parameters in a new species-specific deterrence profile for the encountered species or species category.

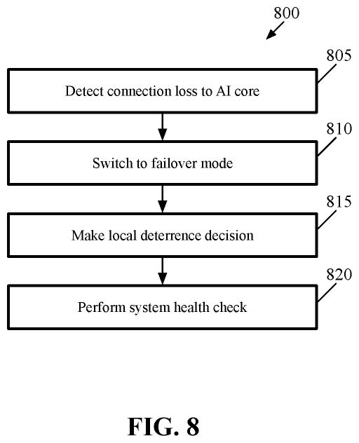

FIG. 8 illustrates an operational flow 800 of a turret node entering failover mode upon losing connection to a central AI core, in accordance with one or more embodiments. Prior to entering failover mode, the turret would have been receiving threat mitigation assignments from the AI core and executing deterrence actions, potentially in coordination with other AI-enabled turret nodes in the wildlife deterrence system.

As shown, the operational flow 800 begins when the turret detects (at 805) a loss of connection to the AI core. This may occur due to failure of the AI core and/or failure of the network connection between the core and the turret. In some implementations, a failover monitoring module executing at the turret node detects and manages network disconnections and failover activation. Some implementations detect when the connection is lost because a heartbeat message times out (i.e., no heartbeat message is received from the core after a set period of time).

In response, the turret switches (at 810) to failover mode (e.g., the failover monitoring module initiates this switch), triggering autonomous local control. In making this switch, the turret retrieves cached predicted bird trajectories and risk assessments. In some implementations, the computing system at the turret includes a cached data repository that is a local storage for AI-generated risk assessments and trajectory data. This cached data includes bird trajectory vectors (spatial and temporal data), ETA and risk level of the different threats, and recommended deterrence parameters (e.g., frequency, intensity, and direction). For a given threat, the turret retains its last assigned role (e.g., lead, support, or observer) from the distributed coordination protocol. The turret maintains this role until communication is restored or the role is reassigned through local AI coordination (if communication is available with other local turrets). In some implementations, the turret node also runs local risk analysis and, if local radar or other sensor data is available, monitors for any new threats. If a local radar is present, this local radar updates the bird position data in real-time and allows the local AI to refine cached trajectories and risk levels.

Based on the cached trajectories and risk assessments (and local radar updates, if available), the turret controller makes (at 815) a local deterrence decision. In some implementations, the turret node activates the deterrence if a high-risk threat is detected, either in the cached risk assessment or based on local analysis of the radar updates. The turret controller aligns the turret toward the predicted bird location, adjusts the frequency, intensity, and direction as per AI-recommended and situational needs, and activates the deterrence bursts with compliant intensity levels (e.g., up to a maximum allowed intensity and within a capped duration). For instance, if a large flock approaches the runway, the turret controller aims the turret ahead of the AI-predicted trajectory and activates bursts. If a single bird lingers near a protected zone, the turret controller might adjust the beam to dynamic positioning and apply low intensity focused bursts. If a flock ignores the initial deterrence, the turret controller increases the intensity within safe limits and adjusts the direction based on the trajectory. Once a threat passes or diverts, the turret controller ceases deterrence and logs the event.

In some implementations, the turret controller imposes security and safety measures while in failover mode. These measures include fail-safe intensity limits to ensure non-harmful and non-lethal operation, encrypting and signing cached AI data to ensure integrity, and a safety override to prevent action near restricted zones based on geo-fencing data. Some implementations include a human override option where a system administrator or other user can log into the deterrent node via a command channel (e.g., an encrypted channel) to either manually activate deterrence or issue an emergency stop command.

Some implementations log all actions while operating in failover mode for later auditing and review. These logs are stored locally and synchronized with the central AI upon reconnection. The records may include activation times, AI trajectory data that is used, deterrent parameters (frequency, intensity, direction), and bird reactions. The logging may capture a complete record of each deterrence event, including the timestamp of threat detection, the cached trajectory data used for targeting, the deterrence parameters applied (frequency, intensity, direction, duration), and the bird's observed response (e.g., continued on path, partial deviation, full diversion, returned after initial deterrence). The logs may also include system status information such as turret health metrics, sensor availability, and any error conditions encountered. The logged data enables post-event analysis to evaluate the effectiveness of autonomous deterrence decisions made during the disconnection period. Upon reconnection, the logs are transmitted to the central AI for integration into the system-wide dataset. This data may be used for AI model retraining to improve future predictions and deterrence recommendations. The logs support regulatory compliance by providing a complete audit trail of all deterrence actions taken during failover operation. In some implementations, the logs are stored in a tamper-resistant format to ensure data integrity for compliance purposes. The retention period for logs may be configured based on regulatory requirements and organizational policies.

Like the centralized AI, the autonomous failover operation of a local turret node may include an adaptive feedback loop in some implementations. If radar is available, the turret AI monitors bird reaction to deterrence using the local radar and adjusts the deterrent parameters dynamically. The turret can increase intensity and/or shift direction if the bird or flock persists and cease its action if the bird or flock redirects and is no longer a threat. The feedback loop may operate on a shorter time scale during failover to compensate for the lack of centralized coordination. The local AI may apply simplified decision rules based on cached species-specific response profiles. If the bird shows partial deviation, the turret may continue with modulated pulses and adjust based on reaction speed. If the bird fully diverts from the hazardous zone, the turret ceases deterrence but continues monitoring until the threat is fully cleared. If the bird returns or re-approaches after initial deterrence, the turret reinitiates deterrence with adjusted patterns and parameters. The local feedback loop enables the turret to maintain effective deterrence even without guidance from the central AI. The turret may cycle through alternative deterrence parameters from its cached profiles if initial attempts are unsuccessful. This autonomous adaptive capability ensures that the turret can respond effectively to changing bird behavior during periods of disconnection.

The failover operational flow 800 of the turret also includes performance (at 820) of a system health check in some implementations. The turret controller monitors the actual deterrence turret (e.g., the LRAD turret), the AI process, and any sensors. If safety is compromised, the controller shuts down the turret node. The health check may include monitoring of hardware status (e.g., turret motor function, speaker/emitter condition, power supply status), software and AI process health (e.g., local AI process responsiveness, memory utilization, processing latency), sensor status (e.g., local radar availability and accuracy, environmental sensors), and safety system status (e.g., intensity limiters, geo-fencing compliance, emergency stop functionality). The health check may be performed periodically (e.g., every few seconds) during failover operation. If any critical component fails or operates outside acceptable parameters, the turret may enter a safe mode or shut down entirely. Health check results may be logged for later analysis and maintenance planning.

If the turret is not shut down, the turret periodically checks for reconnection to the central AI core. The reconnection check may occur at regular intervals (e.g., every few seconds). Once connection to the central AI core is again available, the turret node reconnects. The reconnection process may include authentication and verification to ensure the connection is to the legitimate central AI core. At this point the data (e.g., logged data) and deterrence status (e.g., for any threats monitored and responded to by the turret) are synced with the central core. The sync process may include transmission of all logged deterrence events, bird response data, and system health information collected during the disconnection period. Normal operation (e.g., receiving threat information from the central AI) is resumed. For ongoing deterrence actions, the turret can integrate updated instructions from the central AI once reconnected. The central AI may provide updated trajectory predictions and risk assessments that supersede the cached data. If the turret's role assignment has changed during the disconnection (e.g., due to other turrets taking over), the turret receives its new role assignment. The transition from failover mode to normal operation is designed to be seamless, minimizing any disruption to ongoing deterrence activities. The central AI may also push any updated species-specific deterrence profiles or model updates that were generated while the turret was disconnected. Any deterrence actions that were in progress during reconnection may be handed off to centralized coordination or continued under local control as determined by the central AI.

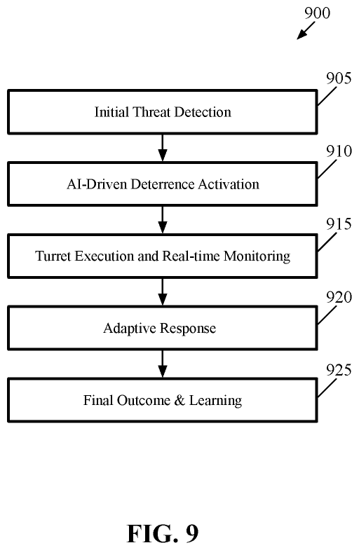

FIG. 9 illustrates an example operational flow 900 of a mitigation scenario, in accordance with one or more embodiments. In this example, the system is deployed at an airport, with a radar detection system and a set of multiple deterrence turrets.

As shown, the operational flow 900 begins when an initial threat is detected (at 905). For instance, the avian radar detects a large flock of birds (e.g., 40+ starlings or other medium-sized birds) approaching the airport runway (e.g., 2 km from the runway and heading towards the approach corridor) during a peak departure window (e.g., 7:30 AM). The radar data tracks the real-time position, speed, and altitude of the flock, which the AI core uses to predict the future trajectory using the spatiotemporal modeling. The AI model at the core also classifies this threat as high risk, given all of the factors and that the trajectory suggests potential bird strike risk within the next two minutes.

Next, the system executes AI-driven deterrence activation (at 910). The central AI core selects a deterrence method such as sound (LRAD) as the primary response and computes suitable parameters (e.g., the angle, intensity, and burst timing). Furthermore, the core assigns a primary (lead) deterrence role to one turret (e.g., Turret 3) and support deterrence roles to one or more other turrets (e.g., Turrets 1 and 5).

With the deterrence determined, the turrets execute this deterrence and real-time monitoring is performed (at 915). The lead turret (Turret 3) directs an acoustic deterrence at a specified angle and intensity (e.g., 85 dB), while the support turrets (Turrets 1 and 5) synchronize their responses to reinforce the impact. Meanwhile, using the stream of radar data, the central AI core continuously tracks the flock trajectory post-deterrence and the feedback loop updates the AI on the reaction of the birds.

The system then employs adaptive response (at 920) based on this feedback. As an example, the AI (using the updated radar data) might detect the flock splitting into two groups, with one group redirecting away from the runway and the second group continuing towards the runway. The first group in this case is a success but the second group represents a persistent threat. In this example, the AI would dynamically adjust the deterrence parameters to, e.g., increase the sound deterrence intensity (such as increasing from 85 dB to 95 dB), activate a secondary deterrence mode at a different sound frequency, and re-position at least one of the turrets (e.g., changing the trajectory angle of support Turret 5).

Finally, in this example, the system produces a final outcome and uses this outcome for learning (at 925). As a result of the adjusted deterrence, the remaining half of the flock diverts away from the runway. The AI logs an effectiveness score for each deterrence mode used and adjusts the AI model for future encounters with similar conditions. Specifically, the primary deterrence was effective at initial displacement but warranted reinforcement for persistent birds. The AI-driven adaptation to increase intensity (or, in other cases, to add flashing lights or other types of deterrence) was warranted to fully mitigate the threat, while multi-turret coordination ensured a rapid and precise response. This data is then shared across all of the deterrence nodes for global optimization within the system. Example adaptations can include adjusting the deterrence intensity scaling algorithm for larger flocks, improved detection of flock splitting to predict secondary threat behavior, and optimization of deterrence sequencing (e.g., multi-mode sequencing if visual deterrence is used in the secondary deterrence) for faster impact.

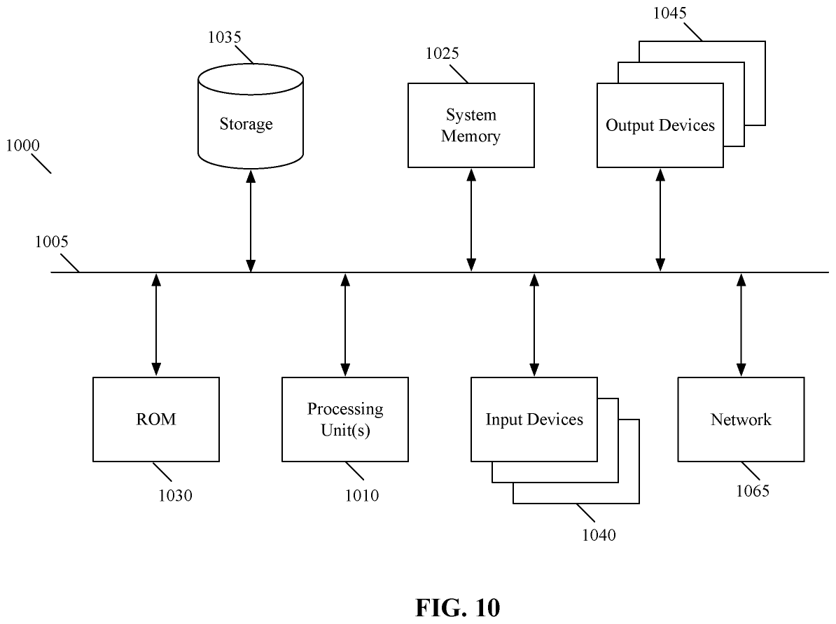

FIG. 10 illustrates a computer system 1000 with which some embodiments are implemented. The computer system 1000 can be used to implement any of the above-described computers and servers (e.g., the central AI processing node, the edge AI modules at the turrets). As such, it can be used to execute any of the above-described processes. This computer system includes various types of non-transitory machine-readable media and interfaces for various other types of machine-readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 (e.g., CPUs, GPUs, and/or TPUs) retrieve instructions to execute and data to process in order to execute the operations described herein. The processing unit(s) may be a single processor or a multi-core processor in different embodiments. The read-only-memory (ROM) 1030 stores static data and instructions that are used by the processing unit(s) 1010 and other modules of the computer system. The permanent storage device 1035, on the other hand, is a read-and-write memory device. This device can be a non-volatile memory unit that stores instructions and data even when the computer system 1000 is off. Some embodiments use a mass-storage device (such as a magnetic or optical disk and its corresponding disk drive) as the permanent storage device 1035.

Other embodiments use a removable storage device (such as a flash drive) as the permanent storage device. Like the permanent storage device 1035, the system memory 1025 is a read-and-write memory device. However, unlike storage device 1035, the system memory is a volatile read-and-write memory, such as a random-access memory. The system memory stores some of the instructions and data that the processor uses at runtime. In some embodiments, the processes described herein are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as a touchscreen that function as both input and output devices.

As shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of computer system 1000 may be used in conjunction with the systems and methods described herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system for automated avian threat detection and deterrence, the system comprising:
a radar detection system configured to collect real-time spatial and temporal avian data including position, velocity, altitude, and radar cross-section (RCS) data;
a central AI processing node comprising a spatiotemporal AI model configured to: (i) analyze sequences of the real-time spatial and temporal avian data to generate an initial trajectory prediction for detected avian activity, (ii) apply learned corrections to the initial trajectory prediction based on patterns observed in historical radar data and species-specific behavioral models to generate a corrected predicted trajectory, and (iii) continuously refine the corrected predicted trajectory as new radar data is received; and
one or more deterrent devices configured to activate deterrence measures directed ahead of detected avian threats along the corrected predicted trajectory to proactively deter detected avian threats before the detected avian threats enter a protected zone.

2. The system of claim 1, wherein the spatiotemporal AI model comprises a transformer-based neural network with multi-head self-attention.

3. The system of claim 1, wherein the spatiotemporal AI model uses positional and temporal encoding to create a unified time-sequenced feature representation, and encodes velocity and RCS data as additional feature channels.

4. The system of claim 1, wherein the spatiotemporal AI model generates output via multi-task heads comprising a trajectory prediction head and a risk assessment head.

5. The system of claim 1, further comprising:
a feedback monitoring unit configured to monitor avian responses to the deterrence measures using ongoing radar data and to dynamically adjust deterrence parameters when the detected avian threats do not change course, including increasing intensity, shifting targeting direction, or activating support deterrent devices for secondary deterrence.

6. The system of claim 1, wherein the one or more deterrent devices comprise one or more of directional acoustic devices, lights, and lasers, each configurable in real-time with adjustable direction, frequency, and intensity.

7. A distributed system for automated wildlife deterrence, the system comprising:
a central AI processing node configured to analyze radar data to generate threat assessments and predicted avian trajectories; and
a plurality of AI-enabled turret nodes, each comprising an edge AI module and a deterrent device, the turret nodes connected by a communication network;
wherein the AI-enabled turret nodes are configured to execute a distributed coordination protocol to negotiate deterrence roles comprising a lead role, a support role, and an observer role, based on each turret node's proximity to a predicted avian trajectory, angular position relative to an avian threat, and current system load, and to perform seamless handover of deterrence responsibility from one turret node to another as avian threats move across coverage areas of the plurality of turret nodes.

8. The system of claim 7, wherein a turret node assigned the lead role is configured to implement a primary deterrence action, turret nodes assigned the support role are configured to implement secondary deterrence actions in response to trajectory deviation or partial deterrence, and turret nodes assigned the observer role are configured to monitor avian reaction and provide feedback.

9. The system of claim 7, wherein the distributed coordination protocol assigns priority rankings based on proximity to a predicted avian trajectory, angular position relative to an avian threat, and current or predicted future system load, and comprises a conflict resolution mechanism for resolving competing role proposals from multiple turret nodes.

10. The system of claim 7, wherein each AI-enabled turret node comprises a failover monitoring module configured to enable autonomous operation based on cached AI-predicted trajectories and risk assessments when communication with the central AI processing node is lost.

11. The system of claim 10, wherein, upon reconnection to the central AI processing node after a period of disconnection, the turret node is configured to synchronize logged deterrence events and bird response data with the central AI processing node and to receive updated trajectory predictions and role assignments.

12. The system of claim 7, wherein the communication network is configured to exchange real-time data among the turret nodes comprising turret activation status, current targeting direction, bird behavior observations, and role assignments using a low-latency messaging protocol.

13. The system of claim 7, wherein the AI-enabled turret nodes are configured to share, during an active deterrence event, real-time updates of avian position relative to a predicted avian trajectory, AI adjustments to a predicted avian trajectory, and deterrence outcome observations, enabling turret nodes assigned the support role to adjust targeting parameters or activate secondary deterrence based on updated trajectory information.

14. The system of claim 7, wherein the seamless handover comprises a receiving turret node inheriting current deterrence parameters from a handing-off turret node, the current deterrence parameters comprising frequency and intensity values adjusted based on a distance and a speed of the avian threat at a time the avian threat enters a coverage area of the receiving turret node.

15. A method for species-specific adaptive avian deterrence, the method comprising:
detecting avian activity using a radar detection system that collects real-time spatial and temporal data;
classifying the detected avian activity based on radar signature characteristics extracted from the real-time spatial and temporal data;
matching the classified avian activity to a species-specific deterrence profile stored in a species-specific deterrence profile database, the species-specific deterrence profile comprising effective deterrence parameters associated with a species or species category;
selecting deterrence parameters from the matched species-specific deterrence profile;
activating one or more deterrent devices based on the selected deterrence parameters; and
monitoring an avian response to the activated deterrent devices and updating the species-specific deterrence profile based on an effectiveness of the selected deterrence parameters.

16. The method of claim 15, wherein each species-specific deterrence profile in the profile database comprises a species identifier, radar signature characteristics comprising a typical RCS range and a flight speed range, effective deterrence parameters comprising frequency ranges and intensity levels, and effectiveness metrics comprising historical success rates for each parameter combination.

17. The method of claim 15, wherein the matching comprises extracting features from the real-time spatial and temporal data comprising RCS signature, flight speed, altitude, flight pattern, and flock density, and applying a similarity metric or classification algorithm to identify a closest matching species-specific deterrence profile in the profile database.

18. The method of claim 15, further comprising:
when no matching species-specific deterrence profile is found in the profile database, applying default deterrence parameters and initiating a learning process to create a new species-specific deterrence profile based on observed deterrence effectiveness.

19. The method of claim 18, wherein the learning process comprises:
initiating deterrence with an initial frequency and an initial intensity level;
monitoring the avian activity to detect a desired trajectory change in response to the deterrence;
when the desired trajectory change is not detected, iteratively increasing at least one of the frequency and the intensity level and continuing to monitor for the desired trajectory change; and
when the desired trajectory change is detected, storing the frequency and the intensity level that achieved the desired trajectory change as effective deterrence parameters in the new species-specific deterrence profile.

20. The method of claim 15, wherein the deterrence parameters comprise species-specific frequency and intensity levels, wherein large birds are deterred using directional acoustic deterrence at 90-110 dB with species-specific distress calls, small flocking birds are deterred using broad-area acoustic deterrence at 70-90 dB with rapid frequency modulation, and raptors are deterred using targeted acoustic deterrence at 100-115 dB with predator call playback, and the method further comprising:
fine-tuning a global AI model on a localized dataset specific to a deployment site via transfer learning, the localized dataset incorporating site-specific radar environments and local species behaviors, enabling faster deployment and higher deterrence effectiveness at the deployment site.
